(19) United States
(12) Patent Application Publication
(10) Pub. No.: US 2025/0148825 A1
(43) Pub. Date: May 8, 2025

(54) SYSTEMS AND METHODS FOR AUTOMATIC DETECTION OF HUMAN EXPRESSION FROM MULTIMEDIA CONTENT

(71) Applicant: CourtScribes, Inc., Ocoee, FL (US)

(72) Inventors: Vincenzo Moscato, Naples (IT); Marco Postiglione, Naples (IT); Valerio La Gatta, Naples (IT); Gennaro Esposito Mocerino, Naples (IT); Michael Breyer, Portola Valley, CA (US)

(73) Assignee: CourtScribes, Inc., Ocoee, FL (US)

(21) Appl. No.: 18/940,551

(22) Filed: Nov. 7, 2024

Related U.S. Application Data
(60) Provisional application No. 63/596,906, filed on Nov. 7, 2023.

(51) Int. Cl. G06V 40/16; G06V 10/764; G06V 20/70

(52) U.S. Cl. CPC G06V 40/174; G06V 10/764; G06V 20/70; G06V 2201/07

(57) ABSTRACT

A system may include a role-matching module, configured to identify the participant of interest in multimedia content contained within the multimedia file. A system may include a scoring module configured to generate a score related to one or more of a plurality of statements, the scoring module comprising: a feature extraction module configured to identify any of a facial expression characteristics, vocal characteristics, and textual characteristics from the multimedia content, and a multi-tier classification module, wherein each tier in the classification module is operative to identify from any of the characteristics in the feature extraction module a classification associated with any of the at least one chunks. A system may include a user interface configured to dynamically display any of audio, text, or video components in relation to a corresponding score of the at least one chunk.

### FIELD OF THE DISCLOSURE

The present disclosure is directed to a system and method for analysis of multimedia content. More specifically, the present disclosure is directed to a system and method for automatic role recognition and detection of human expressions from a user in the multimedia content.

### CROSS-REFERENCE TO RELATED APPLICATIONS

This application claims the benefit of U.S. Provisional Patent Application No. 63/596,906, filed on Nov. 7, 2023, which is incorporated by reference herein in its entirety.

### INTRODUCTION

In criminal investigations, the polygraph has historically served as a conventional technique for discerning instances of deceitful conduct. However, the viability of this approach becomes restricted under specific circumstances, necessitating the utilization of physical contact-based apparatus and human expertise. Moreover, the ultimate decisions derived from polygraph examinations are vulnerable to the influences of errors and bias. Furthermore, individuals involved in illicit activities can circumvent these apparatuses and the discernment of human experts through the employment of well-designed countermeasures.

Given the challenges associated with the application of polygraph-like methodologies, there has been a surge of interest in the development of machine learning-based methodologies to address the task of detecting deception across various sensory modalities, including textual and auditory cues. Unlike conventional polygraph procedures, learning-based techniques for deception detection principally rely on the analysis of data sourced from both deceptive and truthful individuals. Typically, this data is gathered through interactions with human participants, either within controlled laboratory environments or via the means of crowdsourcing. Nevertheless, a notable limitation observed in this data-driven research on deception detection is the paucity of authentic data and the absence of genuine motivation underlying deceptive behavior elicitation. The contrived nature of the experimental settings may preclude the emotional arousal of participants, thereby potentially compromising the generalizability of findings to real-world scenarios.

Zhang et al employed a fine-grained image analysis methodology to identify deception within static images through the examination of facial and emotional expressions. In their initial work, they introduced a feature set that relied upon 58 manually annotated facial landmarks. However, it should be noted that this approach was not entirely automated. Subsequently, Michael et al. extended the approach by introducing a novel feature called “motion patterns.” This feature encompassed the analysis of both head and hand movements, in addition to the automatic tracking of facial landmarks. Notably, their experimentation was primarily conducted within the context of interview scenarios. Expanding on this line of research, Wu et al. leveraged the multi-modal characteristics of video data to identify deceptive behavior within courtroom trial videos. However, these methods do not model any uncertainty and do not provide information about the confidence in a scoring result.

There is a need to be able to detect micro expressions from certain individuals in a call, however, a significant issue arises in identifying which individual(s) need to be monitored. Another prevalent issue arises during a video call with multiple participants having their own video streams and some of the participants either leave or enter the video call while the video call is in progress. Leaving and entering while the video call is in progress causes the various video streams to move around and end in a rearranged order. It is therefore desirable to have a system that is able to recognize specific role positions in performing various software analyses.

### SUMMARY

Aspects of the present disclosure relate to a system for automatic role detection of participants of interest, the system including: a multimedia file including an interview of one or more participants of interest and one or more file components, the one or more file components including one or more of a transcript file, an audio file, and a video file; a processor operable to: segment the one or more file components into a plurality of segments; assign, via an assigning algorithm, a role to each of the one or more participants of interest, wherein the assigning algorithm is a machine learning algorithm, the machine learning algorithm including a computer-implemented method including: receiving, from the one or more file components, an input dataset including the plurality of segments, each of the plurality of segments including one or more partial or complete sentences spoken by the one or more participants of interest; determining a sentence syntax structure for each of the one or more partial or complete sentences from each of the plurality of segments; identifying the one or more participants of interest contained within the multimedia file, wherein identifying the one or more participants of interest includes determining which of the one or more participants of interests is responsible for each of the plurality of segments; classifying, based on the determined sentence syntax, each of the plurality of segments into a plurality of distinct categories; and assigning, based on which of the plurality of distinct categories is identified with respect to each of the one or more participants of interest, a role to each of the one or more participants of interest; a user interface configured to dynamically display the multimedia file.

Aspects of the present disclosure relate to a system, further including a gallery view module configured to isolate one or more video streams, wherein at least one of the one or more video streams is assigned to at least one of the one or more participants of interest.

Aspects of the present disclosure relate to a system, wherein the user interface is further configured to label at least one of the one or more video streams assigned to at least one of the one or more participants of interest with the role assigned to the one or more participants of interest.

Aspects of the present disclosure relate to a system, wherein the role to be assigned to at least one of the one or more participants of interest is a deponent.

Aspects of the present disclosure relate to a system, wherein the plurality of distinct categories include Question, Answer, Clarification Question, Clarification Answer, Other Speakers, Oath Question, and Oath Answer, wherein Answer, Clarification Question, and Oath Answer are sentences articulated by a deponent.

Aspects of the present disclosure relate to a system, wherein only a portion of the plurality of distinct categories is associated with the role.

Aspects of the present disclosure relate to a system, wherein Oath Answer, wherein Answer, Clarification Question, and Oath Answer are associated with the role of a deponent.

Aspects of the present disclosure relate to a method for automatic role detection of participants of interest, the method including: receive, from a front-end server, a multimedia file including an interview of one or more participants of interest and one or more file components, the one or more file components including one or more of a transcript file, an audio file, and a video file; segment the one or more file components into a plurality of segments; receive, from the one or more file components, an input dataset including the plurality of segments, each of the plurality of segments including one or more partial or complete sentences spoken by the one or more participants of interest; determine a sentence syntax structure for each of the one or more partial or complete sentences from each of the plurality of segments; identifying the one or more participants of interest contained within the multimedia file, wherein identifying the one or more participants of interest includes determining which of the one or more participants of interests is responsible for each of the plurality of segments; classifying, based on the determined sentence syntax, each of the plurality of segments into a plurality of distinct categories; assigning, based on which of the plurality of distinct categories is identified with respect to each of the one or more participants of interest, a role to each of the one or more participants of interest; and dynamically displaying, on a user interface, the multimedia file.

Aspects of the present disclosure relate to a method, further including a gallery view module configured to isolate one or more video streams, wherein at least one of the one or more video streams is assigned to at least one of the one or more participants of interest.

Aspects of the present disclosure relate to a method, wherein the user interface is further configured to label at least one of the one or more video streams assigned to at least one of the one or more participants of interest with the role assigned to the one or more participants of interest.

Aspects of the present disclosure relate to a method, wherein the role to be assigned to at least one of the one or more participants of interest is a deponent.

Aspects of the present disclosure relate to a method, wherein the plurality of distinct categories include Question, Answer, Clarification Question, Clarification Answer, Other Speakers, Oath Question, and Oath Answer, wherein Answer, Clarification Question, and Oath Answer are sentences articulated by a deponent.

Aspects of the present disclosure relate to a method, wherein only a portion of the plurality of distinct categories is associated with the role.

Aspects of the present disclosure relate to a method, wherein Oath Answer, wherein Answer, Clarification Question, and Oath Answer are associated with the role of a deponent.

Aspects of the present disclosure relate to at least one non-transitory computer-readable medium including a plurality of instructions that, when executed by at least one processor, are configured to: receive a multimedia file including an interview of one or more participants of interest and one or more file components, the one or more file components including one or more of a transcript file, an audio file, and a video file; segment the one or more file components into a plurality of segments; receive, from the one or more file components, an input dataset including the plurality of segments, each of the plurality of segments including one or more partial or complete sentences spoken by the one or more participants of interest; determine a sentence syntax structure for each of the one or more partial or complete sentences from each of the plurality of segments; identifying the one or more participants of interest contained within the multimedia file, wherein identifying the one or more participants of interest includes determining which of the one or more participants of interests is responsible for each of the plurality of segments; classifying, based on the determined sentence syntax, each of the plurality of segments into a plurality of distinct categories; assigning, based on which of the plurality of distinct categories is identified with respect to each of the one or more participants of interest, a role to each of the one or more participants of interest; and dynamically displaying, on a user interface, the multimedia file.

Aspects of the present disclosure relate to an at least on non-transitory computer-readable medium, further including a gallery view module configured to isolate one or more video streams, wherein at least one of the one or more video streams is assigned to at least one of the one or more participants of interest.

Aspects of the present disclosure relate to an at least on non-transitory computer-readable medium, wherein the user interface is further configured to label at least one of the one or more video streams assigned to at least one of the one or more participants of interest with the role assigned to the one or more participants of interest.

Aspects of the present disclosure relate to an at least on non-transitory computer-readable medium, wherein the role to be assigned to at least one of the one or more participants of interest is a deponent.

Aspects of the present disclosure relate to an at least on non-transitory computer-readable medium, wherein the plurality of distinct categories include Question, Answer, Clarification Question, Clarification Answer, Other Speakers, Oath Question, and Oath Answer, wherein Answer, Clarification Question, and Oath Answer are sentences articulated by a deponent.

Aspects of the present disclosure relate to an at least on non-transitory computer-readable medium, wherein only a portion of the plurality of distinct categories is associated with the role, and wherein Oath Answer, wherein Answer, Clarification Question, and Oath Answer are associated with the role of a deponent.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 illustrates a visualization of a transcribed multimedia undergoing segmentation in accordance with one or more embodiments of the present disclosure.

FIG. 2 illustrates a visualization of a role matching algorithm in accordance with one or more embodiments of the present disclosure.

FIG. 3 illustrates a visualization of a facial feature extraction workflow in accordance with one or more embodiments of the present disclosure.

FIG. 4 illustrates an exemplary extraction of facial action units from a single frame in accordance with one or more embodiments of the present disclosure.

FIG. 5 illustrates a visualization of a residual masking network algorithm in accordance with one or more embodiments of the present disclosure.

FIG. 6 illustrates an exemplary emotion detection unit from a single frame in accordance with one or more embodiments of the present disclosure.

FIG. 7 illustrates a visualization of a three-tiered deception scoring algorithm in accordance with one or more embodiments of the present disclosure.

FIG. 8 illustrates a user interface depicting a target receiving a confidence score in accordance with one or more embodiments of the present disclosure.

FIG. 9 illustrates an overview of the multi-tier classification system in accordance with one or more embodiments of the present disclosure.

FIG. 10 illustrates an example of a confidence score for a statement being classified as truthful in accordance with one or more embodiments of the present disclosure.

FIG. 11 illustrates an example of a confidence score for a statement being classified as deceitful in accordance with one or more embodiments of the present disclosure.

FIG. 12 illustrates an example of a F1 performance in accordance with one or more embodiments of the present disclosure.

### DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

The present disclosure relates to systems and methods for detecting emotions from multimedia content. Specifically, systems and methods for detecting deception from multimedia content.

The system may comprise a role matching module, a scoring module, and a user interface module. In some embodiments, the system may further comprise a gallery view module. Each module may be discussed in more detail herein.

In one embodiment, the system may be configured to receive multimedia content. The multimedia combination may comprise a combination of media files known in the art, including, without limitation, any of video, audio, and text files. However, in another embodiment, any media file may be utilized on its own or in combination with another media file.

In some embodiments, a multimedia file may be extracted from real-time multimedia content. For example, the system may be operative to extract any of the multimedia file from Zoom®, Microsoft Teams®, Skype®, FaceTime® or any other conferencing application that may be desired. Of course, the multimedia file may be received by the system by any method that may be needed or desired. In one embodiment, the system may utilize a Real-Time Messaging Protocol (RTMP) server to manage the real-time multimedia.

Further, in some embodiments, the system may be operative to receive near-real time multimedia content.

In another embodiment, the system may receive non-real-time multimedia content. The non-real-time multimedia content may comprise a multimedia file collected prior to the system receiving it. The non-real-time multimedia content may be received by the system through any method that may be desired.

In one embodiment, the system may be operative to divide the multimedia content 104 into segments 102. It is contemplated that splitting the multimedia content into segments 102 may reduce processing power required for processing the multimedia content 104. Further, it is contemplated by isolating the multimedia content 104, the system 100 may be operative to provide real time, or near-real time, analysis and feedback.

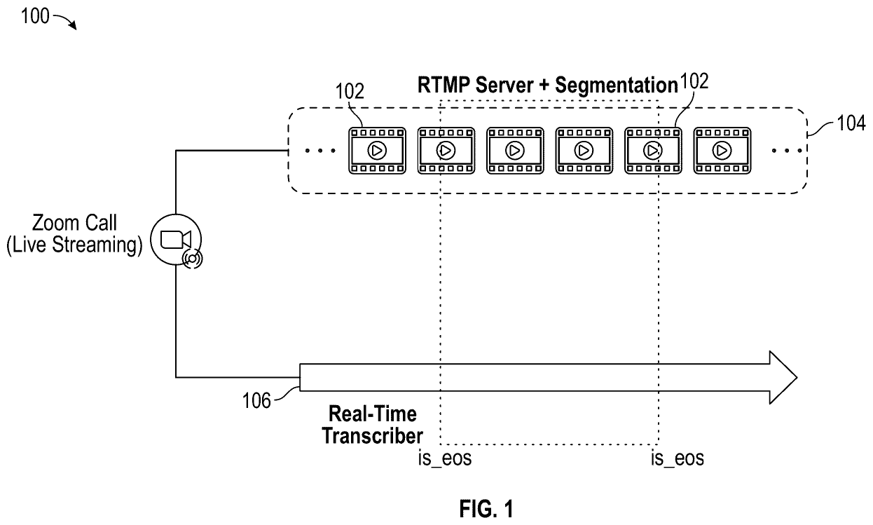

For example, referring to FIG. 1, in one or more embodiments, when the multimedia file 104 is extracted from real-time multimedia content, the RTMP server may divide the real-time multimedia content into segments 102, also referred to as “chunks.” In some embodiments, these chunks or segments 102 are determined by the is_eos metadata provided by the real-time transcription tool, also referred to herein as real time transcription means or transcription means 106. This metadata indicates the end of a sentence. In further embodiments, it may be preferred to divide the real-time multimedia content 104 into segments 102 based on the sentence syntax structure, such as the ending of a sentence, determined by the metadata of the real-time transcription means 106. In the same or other embodiments, the segments 102 may represent several seconds of multimedia content. In one example, the segments 102 may represent from about three seconds to about six seconds. Of course, other time intervals may be utilized when separating the multimedia content and the aforementioned embodiment is provided as a non-limiting example.

In some embodiments, the system may comprise a transcription means 106 such as a transcription tool as described herein. The transcription means 106 may be configured to transcribe the audio file into a transcript, also referred to herein as identified text 202. In one embodiment, the transcription means may be a real-time transcription tool operative to provide real-time, or near-real-time, transcription of audio. For example, the real-time transcription means 106 may be SpeechMatics®. Of course, other real-time transcription tools may be utilized and the aforementioned is provided as a non-limiting example.

In some embodiments, the transcription means 106 may comprise speaker diarization configured to differentiate between participants when speaking.

In an embodiment, the transcription means 106 may be operative to identify an end of a sentence. It is contemplated that identifying the end of a sentence may, in some instances, correspond to a change in a speaking participant. Of course, in other instances, multiple sentences may be spoken by the same participant, and may be attributed as such. In some embodiments, as will be discussed in more detail herein, any sentence may be associated with specific roles and may indicate the role of the participant in the role matching module.

While reference is made throughout to sentences, any portion of speech, including fragments and individual words, may be transcribed.

In an embodiment, the system 100 may be operative to transcribe the audio files according to any of the segments 102 the RTMP server may have divided the real-time multimedia content 104 into. In yet another embodiment, the RTMP server and transcription means 106 may be configured to work in conjunction to divide the multimedia content 104 into segments 102.

In an embodiment, the system 100 may be configured to map the RTMP server segments 102 on the transcript. In some embodiments, the segments 102 may not directly align with the sentences and the system may be operative to identify which segments correspond to each sentence.

### Gallery View Module

In some embodiments, the system may comprise a gallery view module. A person of ordinary skill in the art will recognize that some video conferencing applications, such as Zoom®, may utilize a gallery view wherein video feeds corresponding to multiple participants are visible at a time. In some embodiments, wherein less than all participants are desired for analysis, the gallery view module may be configured to isolate only the desired participant. While reference is made to a singular desired participant throughout, it should be recognized that there may be any number of desired participants. In some embodiments, there may be multiple desired participants comprising various roles and importance. It is contemplated that the participant of interest may be determined according to the role matching module as discussed in more detail herein.

The gallery view module may be operative to identify a video feed associated with the desired participant. In one or more embodiments, the gallery view module may identify the video feed by visible text associated with the individual video feed. For example, some video conferencing applications comprise displaying identifying information associated with the participant, such as the participant's name and/or role.

In the same or other embodiments, the gallery view module may comprise Optical Character Recognition (OCR) to identify various texts in relation to their respective coordinates on the screen. The gallery view module may be operative to identify the video feed associated with the text. In one embodiment the OCR may identify text associated with the desired participant's role, as will be discussed in more detail herein.

In some embodiments, the gallery view module may be operative to isolate only the video feed associated with the desired participant. Any method of isolating only the video feed associated with the desired participant is contemplated. In one embodiment, the system may crop the gallery view to isolate only the video feed associated with the desired participant. In one such embodiment, the system may generate a participant multimedia file comprising the video feed associated with the desired participant. It is contemplated that this may enable the creation of customized videos based on specific processing goals, such as the analysis of the behavior of different speakers in the same meeting. Of course, any processing goals that may be desired are contemplated.

In one embodiment, the gallery view module may be configured to dynamically isolate the video feed associated with the desired participant. A person of ordinary skill in the art will recognize that the arrangement of video feeds may change over time, causing the video feed associated with the participant of interest to vary in position. As such, the gallery view module may monitor the arrangement of video feeds and responsive to detecting a change in orientation, the gallery view module may dynamically isolate the video feed associated with the desired participant.

### Role Matching Module

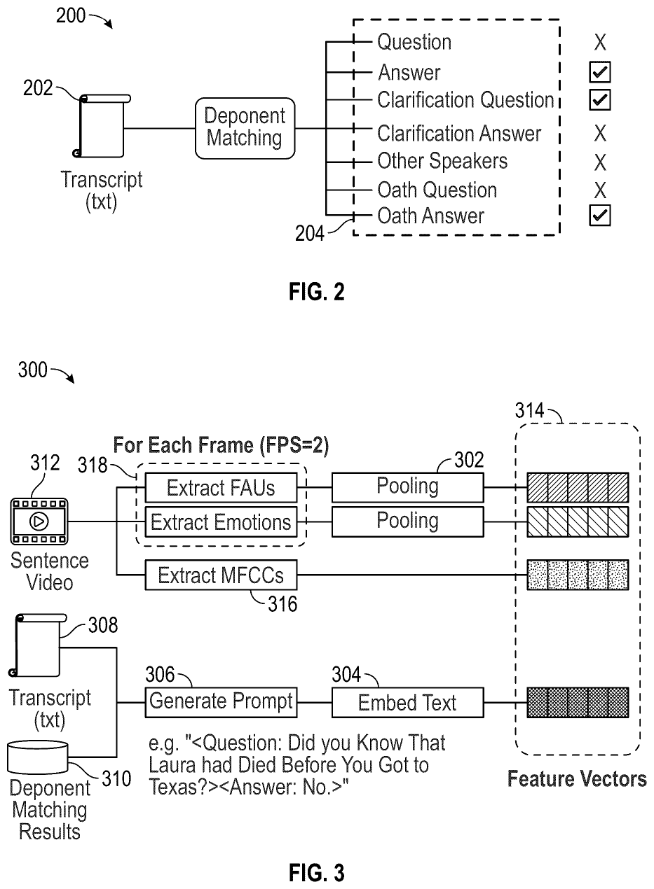

As illustrated in FIG. 2, the assigning algorithm 200, also referred to as a role matching algorithm or role matching module herein, may be operative to identify various participants present in the multimedia content. The assigning algorithm or role matching algorithm 200 may be a machine learning algorithm In one embodiment, the role matching module 200 may be operative to identify the participant of interest in the multimedia content 104. The participant of interest may be any participant that may be desired. In one embodiment, the participant of interest may be a participant having a desired role. For example, the participant of interest may be any of a deponent, job candidate, witness, interviewee, significant other, person of interest, or any other person that may be desired. While the system possesses the versatility to be applied broadly, this role matching algorithm may be referred to herein as ‘Deponent Matching’ (“DM”). DM should be understood to include any of the aforementioned roles along with any other situation in which determining the role of a speaker may be desired.

In one embodiment, as previously discussed, there may be multiple participants of interest. It is contemplated that the participants of interest may be related to each other. For example, when one of the participants of interest is a deponent, another of the participants of interest may be an attorney, a stenographer, or any other person that may be relevant.

In some embodiments, the role matching module 200 may be a computer implemented method hosted on the front-end servers while in other embodiments the role matching module may hosted on the back-end servers. In still other embodiments, some of the aspects of the role matching module discussed herein may be hosted on the front-end server while other aspects are hosted on the back-end server. In some or all of the aforementioned embodiments, the middleware server may act as an intermediary between the front-end and back-end servers.

In one or more embodiments of the present disclosure, the role matching module 200 may be operative to identify a role associated with the participant from the audio component of the multimedia content. In another embodiment, the role matching module may be operative to identify the role associated with the participant from the video component of the multimedia content. In still another embodiment, the role matching module may be operative to identify the role associated with the embodiment from any of the multimedia content. Said identifying may be based on receiving an input dataset from the different file components. The input dataset may include partial or complete sentences spoken

In one embodiment, the role matching module 200 may receive the identified text 202 associated with a video stream from the gallery view module. In such an embodiment, the gallery view module may identify text comprising names and/or roles associated with any of the video streams. The role matching module 200 may receive the identified text 202 and may identify the role of the participant from the text itself. In other embodiments, the role matching module may be capable of identifying the text comprising names and/or roles associated with any of the video streams.

In another embodiment, the role matching module may comprise a list of participants and their respective roles. In such an embodiment, the identification of the role may be dependent on the list of participants.

Returning to an embodiment wherein the role matching module comprises the use of audio components, the role matching module may be operative to identify components of speech as discussed in more detail herein. In some embodiments, the role matching module may transcribe the segments into complete or partial sentences based on syntax structure. These sentences may then be classified into distinct categories based on the sentence's syntax structure using a specialized role-matching algorithm or assigning algorithm. Based on the distinct category the segment is classified as, the assigning algorithm may assign a particular role to the participant the segment is associated with. This algorithm, termed ‘Deponent Matching’, may be adept at determining the role of the speaker within a sentence, focusing primarily on identifying statements made by the person(s) of interest, such as, for example, a deponent or other interviewee. In one or more embodiments, the role matching module may be operative to furnish contextual information about the speaker's role within a given sentence. This role matching algorithm may have the capability to scrutinize the veracity and authenticity pertaining to the specific role under scrutiny.

In one or more embodiments of the present disclosure, the role matching module may utilize a process that entails the examination of a detected sentence through our DM module, which, in turn, determines whether the sentence is attributable to the deponent or other person(s) of interest. In some embodiments, the role matching module may comprise a plurality of categories that speech may be directed into. For example, in the deponent example, the role matching module 200 may comprise categories 204 associated with any of a Question, Answer, Clarification Question, Clarification Answer, Other Speakers, Oath Question, and Oath Answer. Some of the categories, for example Answer, Clarification Question and Oath Answer may be associated with the role of deponent.

In one embodiment, the units of classified text may be correlated with the user's role identified in the role matching module 200. For example, the participant whose speech is classified as Answer, Clarification Question and Oath Answer may be classified as the deponent.

Of course, any other category may be utilized. Indeed, in some embodiments, the categories may be determined according to a scenario the system is applied to.

Further, the role matching module 200 may be operative to selectively identify the role in instances where text associated with another participant may be associated with the categories associated with a role.

In one or more embodiments, the role matching module 200 may be operative to identify each participant of interest by labeling each participant of interest's video stream with their matched role.

### Scoring Module

The scoring module may comprise a feature module configured to identify one or more characteristics in the multimedia content, and, from the one or more characteristics, the scoring module may generate a score. In one embodiment, the score may be associated with a likelihood of deception. In another embodiment, the score may be associated with a likelihood of truthfulness. Of course, the score may be associated with any characteristic that may be desired and the scoring module may be trained accordingly. For example, the scoring module may be trained to recognize enthusiasm and/or conviction in a setting where detecting truthfulness is not wanted or allowed. Other examples the scoring module may be trained to detect include, but not limited to, skepticism, agreement/disagreement, comfort/discomfort, certainty/confidence, compliance/defiance, patience/impatience, curiosity, and/or attentiveness/boredom.

In the interest of clarity, further embodiments of the invention will be discussed with reference to deception scoring. However, any of the embodiments may be utilized with any characteristic that a person of ordinary skill in the art may desire.

In one embodiment, the scoring module may be multi-modal and operative to generate the score from a plurality of the one or more characteristics identified by the feature extraction module. The characteristics may be any characteristic that may be desired. As a non-limiting example, the characteristics may be any of a facial expression characteristics, vocal characteristics, and textual characteristics.

### Facial Expression Characteristics

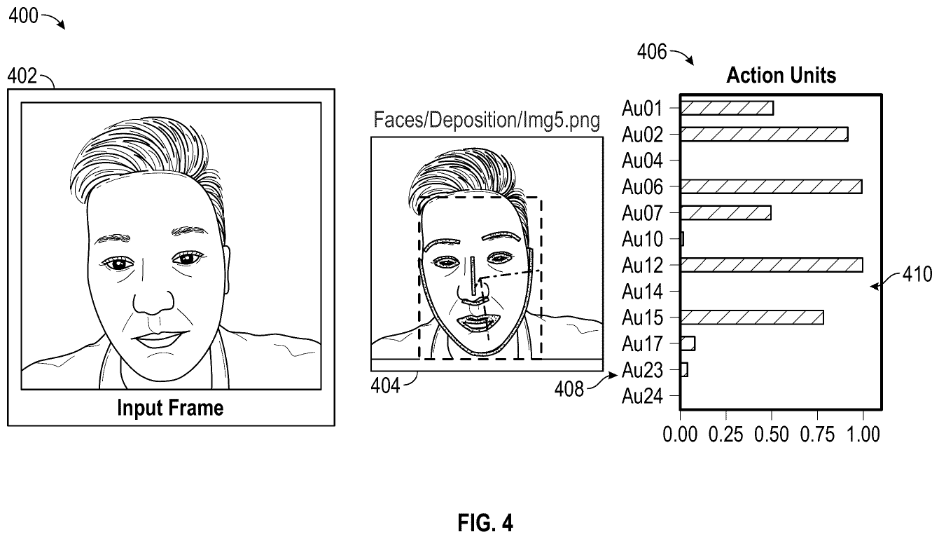

Turning to FIGS. 3 and 4, the system may comprise a facial recognition unit 300, 400 configured to identify a participant's face 402 and changes in facial expression 404 in order to determine a feature score 314. In one or more embodiments, each frame from the segmented audio 312 is analyzed to extract changes in facial features. In other embodiments, only some frames are analyzed to extract changes in facial features. A person of ordinary skill in the art will recognize many methods by which facial recognition may occur, any of which may be utilized in the invention. In one or more embodiments, Mel-frequency cepstral coefficients (MFCCs) may be used for feature extraction 316. In some embodiments, the extracted features of the feature extraction 318 are merged in a pooling phase 302. In the same or other embodiments, text embeddings 304 are derived from a prompt 306 generated by considering both the transcript 308 and the corresponding deponent matching 310 (“DM”) results. When classifying a sentence, previous sentences with their respective DM 310 labels may be taken into account. The input prompt for the transformer-based embedding module may be structured as follows: “<DM_Label: Text><DM_Label: Text> . . . <DM Label: Text>”. The final “<DM_Label: Text>” may correspond to the sentence currently under classification, while the preceding ones may provide valuable context.

For example, available libraries, such as PyFeat, which store a plurality of labeled images, each image comprising coordinates of a bounding box, may be utilized to identify and delineate the bounding box around the participant's face. In some embodiments, the bounding box may represent a ground truth.

In an embodiment, the facial expression characteristics may comprise facial action units 408 (FAUs) extracted from a video component of the multimedia content. A person of ordinary skill will recognize that FAUs are a component of the Facial Action Coding System 406 (FACS) which correlates facial expressions with related emotions. For example, AU01 is generally attributed to an inner brow raise and may be related to sadness, surprise, and fear, AU17 is generally related to a chin raise and may be related to disgust, and AU23 is generally attributed to a lip tightening and may be related to anger. The aforementioned are provided as non-limiting examples only and should not be considered limiting.

Each feature in the face may be examined and may be assigned a meaning according to its position in relationship to another feature. It is contemplated that a weight 410 may be given to each FAU associated with the FAU's intensity. One example of FAU weighting 410 is provided in FIG. 4.

Extracting the FAUs from the video component may comprise capturing at least one frame from the video. In one embodiment, the number of frames captured from the video may be configured to capture micro-expressions.

For example, and without limitation, for each second of video about eight frames may be extracted. It is contemplated that extracting eight frames per second (FPS) may be sufficient to extract most micro-expressions. Of course, other rates of FPS are contemplated and any frame rate suitable for identifying micro-expressions may be utilized.

It is contemplated that the system may be operative to detect any number of FAUs from each frame. In one embodiment, the FAUs may comprise from about 12 to 22 units. In some embodiments, the system may detect less than all the FAUs present. For example, the system may be operative to detect only FAUs that may be associated with particular characteristics. While any number of FAUs may be associated with particular characteristics, it is contemplated that isolating less than all of the FAUs may improve results. For example, isolating about four characteristics for each micro-expression may result in less noise and more accurate results.

In one embodiment, the facial expression characteristics may be identified on any or all of the participants. In another embodiment, the facial expression characteristics may be identified only for the participant of interest. It is contemplated by extracting only the video stream associated with the participant of interest, as discussed with reference to the gallery view module, the system may reduce facial expressions in the video and, thus, may reduce the processing power. Of course, in another embodiment, the system may be configured to identify the facial expression characteristics on less than all participants visible in the video.

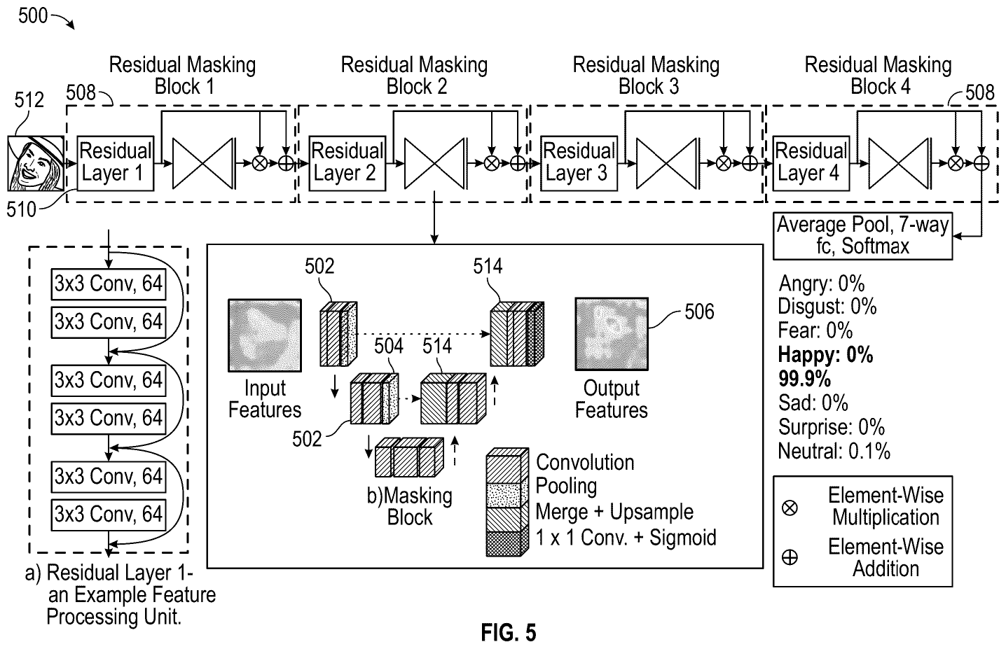

In one embodiment, as shown in FIG. 5, the facial expression characteristics of a single frame 512 may be identified according to residual masking networks 500. The residual masking networks may comprise an initial convolutional layer 502 and a max-pooling layer 504 operative to generate a feature map 506. In some embodiments the feature map 506 may comprise a number of channels (“C”), a width of each channel (“W”), and a height of each channel (“H”). The feature map 506 may be defined as C×W×H, wherein C, W, and H, may be any desired value. For example, in some embodiments, the feature map 506 may be defined as 64×56×56. A person of ordinary skill will recognize that the residual masking networks 500 may comprise a plurality of residual masking blocks 508, such as four. The plurality of residual masking blocks 508 may, in some embodiments, comprise a residual layer 510 for feature processing and a masking block 508. In one embodiment, the masking block 508 may produce weights for a corresponding feature map. A person of ordinary skill in the art will recognize that the feature map 506 may initially be F∈R^{C×W×H}. The feature map 506 may be passed through the residual layer (R) 510 to generate a coarse feature map FR=R(F), where FR∈R^{C×W×H}. In some embodiments, the masking block 508 may calculate an activation map (FM) which comprise values between zero and one. The values in the activation map may be calculated according to FM=M(FR). The output of the residual masking block may be a refined feature map calculated by:

$$FN = FR + FR ⊙ FM$$

where ⊙ denotes element-wise multiplication.

In one embodiment, the masking block 508 is based on a U-net structure, known by a person of ordinary skill in the art for being operative to effectively localize small objects. It is contemplated the number of pooling layers 504 and up-sampling layers 514, which may be known in the art, in the masking block may depend on the spatial feature size of the residual input unit. One non-limiting example of residual masking is illustrated in FIG. 5.

In another embodiment, JAÂ-Net may be utilized. A person of ordinary skill in the art will recognize that JAÂ-Net is a known technique that may provide end-to-end deep learning for joint facial action unit detection and face alignment via adaptive attention. It is contemplated that JAÂ-Net may utilize facial landmarks to provide precise FAU locations, thus, facilitating the extraction of significant local features for FAU detection.

It is contemplated that JAÂ-Net may extract multi-scale feature from local regions. In one embodiment, a feature map from a plain convolutional layer may be divided into patches. Each patch may be processed with an independent convolutional filter. It is contemplated that the multi-scale feature extraction may be represented as:

$${F}^{′} = {\sum }_{i = 1}^{n} Conv ( {F}_{i} ) ,$$

where Conv(·) is the convolution operation and n is the number of patches.

In some embodiments, facial alignment may occur to estimate a location of facial landmarks (L), for example, and without limitation, eyes, mouth, and lips. The facial landmarks may be estimated according to:

L′=Estimate(I)

where I is the input facial image and L′ is the set of estimated landmarks.

In an embodiment, global featuring learning may occur to capture underlying structures and textures of a face. The global feature (G) may be extracted according to:

G′=Extract(I),

where Extract (·) is the global feature extraction function.

In some embodiments, an adaptive attention learning module known in the art may be utilized. It is contemplated that adaptive attention learning module may comprise an attention map and may be operative to adaptively refine the attention map according to the FAUs. The refined map (A′) may be generated according:

A′=Refine(A,F′),

where Refine (·) is the attention refinement function.

It is contemplated that utilizing the JAÂ-Net framework may jointly model FAUs and face alignment using deep neural networks. More particularly, the adaptive attention learning module may refi the attention map of each FAU based on predicted facial landmarks and may, in some embodiments, lead to enhanced performance in FAU detection and facial alignment.

### Emotion Characteristics

In a further embodiment, emotions may be identified from the video. More particularly, emotions of the participant of interest may be extracted. In one embodiment, the emotions may be extracted according to each sentence in the transcript. In some embodiments, the emotions may be extracted according to less than all of the sentences in the transcript, for example the first five seconds of each sentence. In another embodiment, the emotions may be extracted according to each segment of the multimedia content.

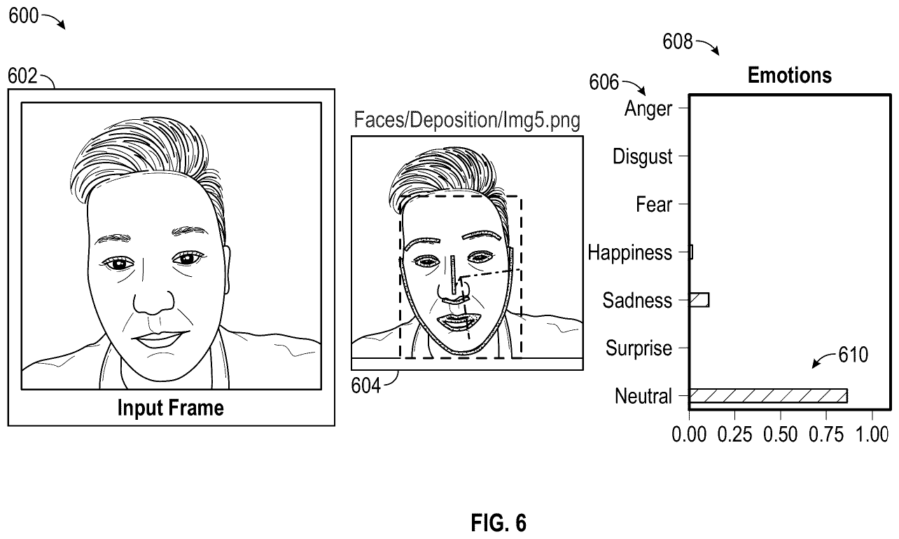

FIG. 6 illustrates an emotion identifying unit 600 that uses a single frame 602 from a multimedia file to identify a range of emotions in accordance with one or more aspects of the present disclosure. In one or more embodiments, the emotion identification unit 600 may analyze the changes in the facial features 604. The emotions may be identified according to any manner that a person of ordinary skill in the art may desire. For example, PyFeat or other related software may be utilized to identify the emotions. Each of these facial features may then be associated with particular emotions 606. In a further embodiment, each of these facial features 604 are given various weights 610 to each of the one or more emotions 606 the facial feature 604 is associated with. In the same or other embodiments, the weights 610 of the detected facial features 604 are aggregated to form an emotion chart 608 that represents the likelihood that the subject in the single frame 602 is experiencing a given emotion 606.

It is contemplated that the system may be operative to identify any number of emotions. For example, the system may be operative to identify any of anger, disgust, fear, happiness, sadness, surprise, enthusiasm, conviction, skepticism, agreement/disagreement, comfort/discomfort, certainty/confidence, compliance/defiance, patience/impatience, curiosity, attentiveness/boredom and neutral. However, in another embodiment, the system may be operative to consider less than all emotions. It is contemplated that this may occur as emotions are trained and become more accurate. Thus, the characteristic predictions may be more accurate over time and may improve the performance of the system.

### Vocal Characteristics

In yet a further embodiment, the vocal characteristics may comprise a frequency of an audio of the multimedia content. In one such embodiment, the vocal characteristics may comprise a Mel-frequency cepstral coefficient (MFCC) extracted from the audio. The MFCC may represent spectral characteristics of sound, for example, any sentence in the audio file may comprise spectral characteristics that may be represented. More specifically, in some embodiments, a raw audio signal may be transformed into a frequency domain signal, and then the Mel-frequency scale may be used to approximate the audio signal into sound frequency. The MFCC may then be computed. A person of ordinary skill in the art will recognize that MFCC is known in the art and any manner of converting the audio to an MFCC is contemplated. For example, an audio signal may be extracted from the audio file and then MFCC extraction may be performed, in part or in its entirety, by Librosa Python library. In one embodiment, a power spectrum (P (k,t)) for a time (t) may be calculated using:

$$P ( k , t ) = {\vert FFT ( s ( t ) ) \vert}^{2} .$$

A Mel scale (m) may be calculated according to:

$$m = 2595 \times {log}_{10} ( 1 + \frac{f}{700} ) .$$

The power spectrum may be represented on the Mel Scale, in one embodiment, as a series of overlapping triangular filters. Each filter may be multiplied by the power spectrum to yield the Mel-spectrum (M(k,t)). In some embodiments, the logarithmic nature of human amplitude perception may be accounted for by calculating the logarithmic of the Mel-spectrum:

L(k,t)=log(M(k,t)).

In one embodiment, the MFCCs may be obtained using Discrete Cosine Transform (CDT). For example, the MFCCs (C(n,t)) may be calculated by:

$$C ( n , t ) = {\sum }_{k = 0}^{K - 1} L ( k , t ) cos ( \frac{π n ( 2 k + 1 )}{2 K} ) ,$$

where K is the number of Mel filters and n ranges from about 1 to 13.

It is contemplated that the system retaining only the significant lower-order coefficients may, in some embodiments, offer a compact, yet informative representation of the spectral characteristics of an audio signal. In some embodiments, the lower-order coefficients may comprise aspects most relevant to human auditory perception.

### Textual Characteristics

In an embodiment, the textual characteristics may be extracted from textual data extracted from the multimedia content. For example, the textual data may comprise any of the transcript generated from the multimedia content. It is contemplated that the textual data may be classified into various units. For example, the textual data may be classified as any of the Question, Answer, Clarification Question, Clarification Answer, Other Speakers, Oath Question, and Oath Answer discussed herein. The system may, in some embodiments, be operative to identify the speaker of each of the units.

In one embodiment, the textual characteristics may be derived from at least any of the text in the transcript. In an embodiment, the textual characteristics may be derived from any of the text in the transcript and any of the classifications associated with the text. In one such embodiment, the textual characteristics may be derived from any of the text in the transcript, role of the participant, and classification of the text.

In still another embodiment, the textual characteristics may be derived from sentences surrounding the desired text. For example, when the text is classified as an Answer the Question may be considered to provide context. In one embodiment, the feature extraction module may comprise a transformer-based embedding module configured to take into account the surrounding sentences to provide context to the desired text.

Each of the characteristics extracted from the feature extraction module may be transposed to a vector by leveraging transformer models. Transformer models may comprise a machine learning model configured to handle sequential data. A person of ordinary skill in the art will recognize that text is one type of sequential data, however, other types are available. In one embodiment, the transformer model may comprise converting the text into vectors. In an embodiment, this may comprise breaking the text into segments, called tokens, in a process called tokenization. It is contemplated that the tokens may vary in length, for example, from a few characters to multiple words. In a further embodiment, the transformer model may comprise mapping each token to a vector, in a process known as encoding, to transform the text into machine-readable text. In one embodiment, the vector may be a list of numbers, however, any list that the system may recognize is contemplated. In another embodiment, the transformation model may further comprise a process of embedding. Embedding may comprise self-attention means to understand the relationship between tokens in a sequence. In one embodiment, embedding may comprise assigning weights to tokens in the vector in relation to other tokens in the vector. Assigning weights to the tokens in the vector may, in some embodiments, create new vectors operative to capture the relationships between vectors. It is contemplated that converting the text to vectors may enable mathematical operations and computations that may be utilized by the system to train the data. In some embodiments, the vectors may capture semantic information from text. For example, words with similar meanings may be represented by vectors that are close to each other in a mathematical space, which a person of ordinary skill in the art will recognize as advantageous in machine-learning applications.

### Example 1: Transformer Model

In one embodiment, the transformer model may be a neural network configured for sequence-to-sequence tasks. For example, the transformer model introduced by Vaswani et al. in 2017, may be utilized. A person of ordinary skill in the art will recognize that any transformer model that may be known in the art is contemplated and the discussed model is provided as a non-limiting example only.

In an embodiment, the transformer model may be configured to provide a representation of the input. In one embodiment, this may be performed through tokenization, where an input sentence is segmented into tokens (i.e., x₁, x₂, . . . , xₙ). Each of the tokens (xᵢ) may be mapped on the vector through embedding. In one embodiment, mapping the vector may be executed according to:

E(xᵢ)=Embed(xᵢ).

Following embedding, the transformer model may, in some embodiments, comprise positional encoding operative to retain an order of the tokens from the input sentence. Retaining the order of the tokens from the input sequence is contemplated to take into account the order of words in the sentence, which a person of ordinary skill will recognize may result in contextual recognition of words and/or phrases. It is contemplated that positional encoding may be carried out according to:

$$P ( {x}_{i} ) = E ( {x}_{i} ) + PositionalEncoding ( i ) .$$

In one embodiment, the self-attention means may utilize scaled-dot product attention. In such an embodiment, the scaled-dot product attention may be calculated according to:

$$Attention ( Q , K , V ) = Softmax ( \frac{{QK}^{T}}{\sqrt{{d}_{k}}} ) V ,$$

where Q is a set of queries, K is a set of keys, V is a set of values, and dₖ is a dimension of the keys.

It is contemplated that the scaled-dot product attention may permit the transformer model to identify compatibility between queries and keys. It is further contemplated that the scaled-dot product attention may permit the transformer model to focus on less than all the queries, keys, and values. Of course, any attention means that a person of ordinary skill in the art desires may be utilized in the current invention.

In some embodiments, the transformer model may comprise multi-head attention operative to permit the model to focus on a desired part of the queries, keys, and values. In such an embodiment, the transformer model may split any of the queries, keys, and values into different “heads.” Each head may be calculated according to:

headᵢ=Attention(QW_{Qi},KW_{Ki},VW_{Vi}).

In an embodiment, each head, may be concatenated to another of the head; and linearly transformed according to:

$$MultiHead ( Q , K , V ) = Concat ( {head}_{1} , … , {head}_{h} ) {W}_{O} .$$

In one embodiment, each MultiHead attention output may be passed through a position-wise feed-forward network. For example, each MultiHead attention output may pass through the following position-wise feed-forward network:

$$F ( X ) = Re LU ( {XW}_{1} + {b}_{1} ) {W}_{2} + {b}_{2} ,$$

where X is an input, ReLu is any activation function known in the art, and W and b are learnable parameters. More specifically, W and b are parameters that the model may generate during training.

It is contemplated that the position-wise feed-forward network and the MultiHead attention may, in some embodiments, comprise residual connections. It is contemplated that the residual connections may be utilized to train any of the models. For example, training may occur according to:

$$Y = LayerNorm ( X + SubLayer ( X ) ) ,$$

where SubLayer may interchangeably refer to the position-wise feed-forward network and the MultiHead attention.

In one embodiment, the transformer model may further comprise stacking layers of positional encoding and decoding. It is contemplated that stacking the layers may permit the transformer model to learn different aspects of the data. For example, some layers may be trained according to local and/or fine-grained patterns while other layers may be trained according to abstract and/or global patterns. Further, a person of ordinary skill in the art will recognize that transformer models are configured to handle complex relationships and dependencies in data. Stacking layers may permit the transformer model to consider wider context and longer-range dependencies, which may, for example, assist in tasks such as translations, summarization, and question answering.

It is contemplated that in some embodiments, such as when used for classification tasks, the transformer model may be operative to obtain class probabilities. For example, the sequence may be passed through a linear layer and a function known in the art such as, Softmax, to obtain classification according to:

$${P}_{class} = Soft max ( {Y}_{final} {W}_{c} + {b}_{c} ) .$$

The scoring module may be further configured to score each of the vectors associated with the features.

In one embodiment, the scoring module may comprise a multi-tier classification algorithm or model designed to be ran on a non-transitory computer-readable medium. In an embodiment, each tier in the multi-tier classification model may be optimized for a particular metric. For example, the tier may be optimized to identify truthfulness, deceitfulness, enthusiasm, conviction, skepticism, agreement/disagreement, comfort/discomfort, certainty/confidence, compliance/defiance, patience/impatience, curiosity, attentiveness/boredom, or any other metric that may be desired such as skepticism, agreement/disagreement, comfort/discomfort, certainty/confidence, compliance/defiance, patience/impatience, curiosity, and/or attentiveness/boredom.

Each tier may be optimized according to any of the feature vectors extracted from the multimedia content. In one embodiment, each feature vector may be trained individually for each tier. In another embodiment, a plurality of the feature vectors may be trained in conjunction with one another for each tier.

In one embodiment, each tier of the multi-tier classification model may be trained independently of another of the tiers. It is contemplated that independently training the tiers may permit feature characteristics to be present in any number of tiers without affecting analysis in another of the tiers.

In one embodiment, any of the multi-tier classification model may be trained according to late fusion model. In some embodiments, any of the training may comprise a pre-identified metric. However, in other embodiments, all of the metrics for the training may be identified by the system. In an embodiment, any of the multi-tier classification model may be trained according to a received user input. Further, in another embodiment, any of the multi-tier classification model may be trained according to the use of the system. For example, when the participant of interest is a person of interest in a criminal investigation the system may vary from when the participant of interest is a deponent in a civil litigation instance.

As such, the metrics for each tier may be unique to the individual tier according to its individual training. In one embodiment, any of the FAUs, MFCCs, emotion, text embedding, or combination thereof may be used to train the tier. In another embodiment, the tier may be trained by a combination of some or all of the FAUs, MFCCs, emotions and text embedding.

In an embodiment, the score(S) may be trained according to a late fusion model defined as:

$$S = {\sum }_{i = 1}^{k} {α}_{i} {S}_{i} ,$$

where i ranges from 1 to k and αᵢ is a late fusion weight and Σᵢ₌₁^{k} αᵢ=1, k representing the number of feature types considered.

Each feature may be associated with at least one classifier configured to produce a score. In one embodiment, the score may signify a probability of the analyzed segment having a characteristic. For example, and without limitation, the score may signify a probability of a sentence being false.

The determination of late fusion weights is carried out through random-search and cross-validation techniques aiming to optimize the target metric. Specifically, optimizing target metrics may comprise finding the best set of weights to maximize a particular performance metric. A person of ordinary skill in the art will recognize that random-search may comprise testing a plurality of different sets of weights to identify which set of weights results in high performance. In one embodiment, all data except for one individual's data is used to train the model, and the left-out individual's data is used to test the mode's performance, which may, in some embodiments, be referred to as leave-1-out cross validation. It is contemplated that this process may be repeated, each time leaving out a different individual's data for testing. In some embodiments, the process may be repeated for each individual data set being left out. The average performance across all these different tests may be an indicator of the mode's likely performance. It is contemplated that the random-search and cross-validation techniques may be repeated to train the system. More specifically, the random-search and cross-validation techniques may be repeated each time with a different set of weights for the late fusion. In an embodiment, the set of weights that results in the best average performance is chosen as an optimal set for the model.

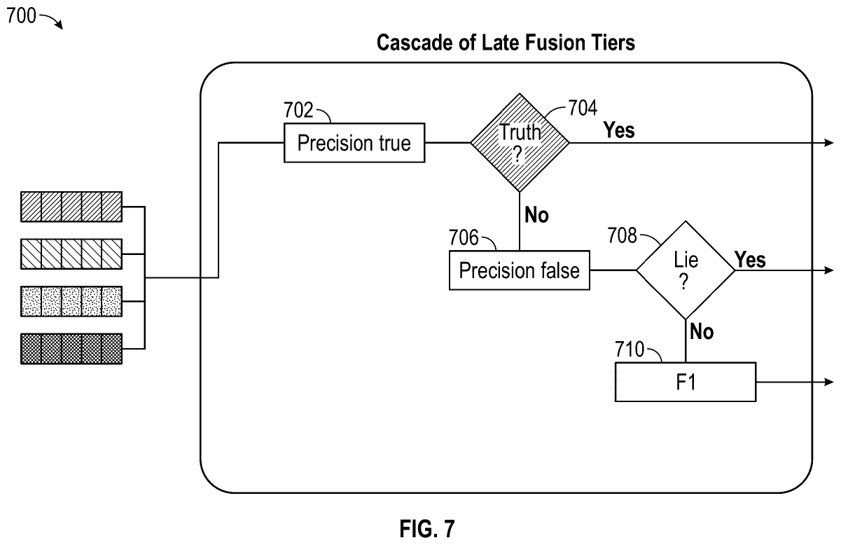

In an embodiment, as shown in FIG. 7, the multi-tier classification model 700 may comprise a first tier step 702. In one embodiment, the first tier step 702 may be configured to identify a truthfulness step 704 in a statement. For example, the first tier step 702 may identify an answer, identified by the role-matching module, and may be able to predict the truthfulness in the statement. In another embodiment, the first tier step 702 may be configured to identify conviction/enthusiasm, skepticism, agreement/disagreement, comfort/discomfort, certainty/confidence, compliance/defiance, patience/impatience, curiosity, or attentiveness/boredom in a statement.

In an embodiment, the multi-tier classification model may comprise a second tier step 706. The second tier step 706 may, in some embodiments, be configured to identify a false statement step 708. More particularly, the second tier step 706 may be configured to identify falsehood and/or deception in a statement. In another embodiment, the second tier step 706 may be configured to identify a lack of conviction/enthusiasm, skepticism, agreement/disagreement, comfort/discomfort, certainty/confidence, compliance/defiance, patience/impatience, curiosity, or attentiveness/boredom in a statement.

In an embodiment, the multi-tier classification module may comprise a third tier step 710. The third tier step 710 may, in some embodiments, be configured to analyze the statement for both truthfulness and falsehood or conviction/enthusiasm, skepticism, agreement/disagreement, comfort/discomfort, certainty/confidence, compliance/defiance, patience/impatience, curiosity, or attentiveness/boredom and the lack thereof.

In one embodiment, the multi-tier classification module 700 may be operative to carry out a method comprising the steps of: passing the feature vectors of an input sentence through the first-tier configured to identify truthfulness in step 702; responsive to the feature vector being below a first-tier confidence threshold at step 704, passing the feature vector through the second tier configured to identify falsehood at step 706; and responsive to the feature vector being below a second-tier confidence threshold at step 708, passing the feature vector through the third tier configured to classify both true and false statements at step 710. In another embodiment, the multi-tier classification model may follow the same steps for conviction, enthusiasm, or any other previously stated emotion so that a level of confidence for emotion being detected, or the lack thereof, may be identified.

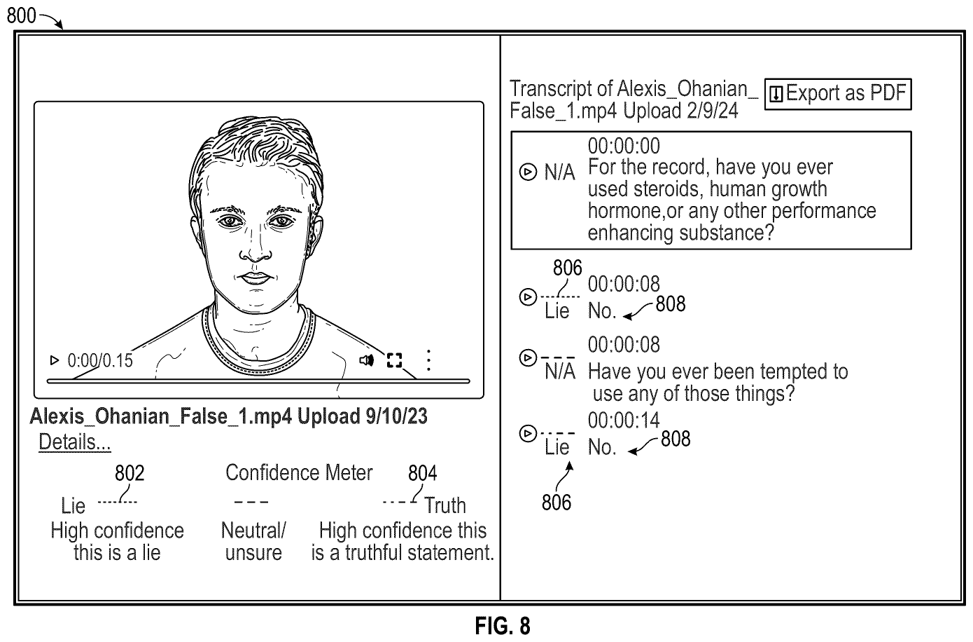

If the feature vector is above the confidence threshold of the first or second tier, the system may classify the statement according to the results of the tier. For example, in embodiments wherein the first tier is associated with truthfulness and the feature vector is above the first-tier confidence threshold, the statement may be classified as true. If the first tier is below the confidence threshold and the second tier is associated with falsehood and the feature vector is above the second-tier confidence threshold, the statement may be classified as false as depicted in the user interface as shown in FIG. 8.

In instances where the feature vector is below both first and second tier thresholds, the feature vector may be passed through the third model. The third model may be configured to identify the characteristic of the statement when the first and second thresholds are not met. For example, when the statement is not classified as true in the first tier and not classified as false in the second tier, the third tier may be utilized to classify the statement.

In one embodiment, the third model may classify the statement according to:

$$prediction ( F 1 ) = \{ \begin{matrix}truth , & {s}_{F 1} \leq 0.5 \\ lie , & {s}_{F 1} > 0.5\end{matrix} .$$

In one embodiment, the system may be configured to assign a confidence weight (Wₘ) to each model (M). In an embodiment, the confidence weight (Wₘ) may be based on a level of confidence, interchangeably referred to as a model's trustworthiness, of the models in the three tiers, i.e., F1, Pₜᵣᵤₑ, P_{false}. For instance, the confidence weights (Wₘ) may be assigned according to:

$${w}_{M} = \{ \begin{matrix}3 , & M ∈ \{ {P}_{true} , {P}_{false} \} \\ 2 , & M ∈ \{ F 1 \}\end{matrix} ,$$

meaning that the Pₜᵣᵤₑ and P_{false} models are predicted with more confidence than the F1 model.

In one embodiment, the final score (S_{f}) may be generated by increasing the distance of the prediction of any model, i.e., F1, Pₜᵣᵤₑ, P_{false}, from the prediction boundary. For example, the final score (S_{f}) may be determined according to:

$${s}_{f} = 0.5 - {w}_{M} ( 0.5 - {s}_{M} ) ,$$

where S_{M} may be the prediction score from any model, i.e., F1, Pₜᵣᵤₑ, P_{false}, and 0.5, or 50%, is the prediction boundary. In some embodiments, the confidence weight (Wₘ) may control the distance from the prediction boundary.

### Example A

$${s}_{{P}_{true}} = 0.4 ⇒ {s}_{f} = 0.5 - 3 ( 0.5 - 0.4 ) ⇒ {s}_{f} = 0.2 \qquad ( A )$$

In example (A), the first model in the three-tier cascade, i.e., Pₜᵣᵤₑ, has predicted a true statement (S_{P}_{ₜᵣᵤₑ}=0.4<0.5). As a result, the final score (S_{f}) may be determined according to the above-mentioned formula, using the score S_{P}_{ₜᵣᵤₑ} provided by Pₜᵣᵤₑ model and its confidence weight (Wₘ):

$${s}_{f} = 0.5 - {w}_{M} ( 0.5 - {s}_{M} ) = 0.5 - 3 ( 0.5 - 0.4 ) = 0.2 .$$

### Example B

$${s}_{{P}_{true}} = 0.6 , {s}_{{P}_{false}} = 0.55 ⇒ {s}_{f} = 0.5 - 3 ( 0.5 - 0.55 ) ⇒ {s}_{f} = 0.65 \qquad ( B )$$

In example (B), the first model in the three-tier cascade, i.e., Pₜᵣᵤₑ, has not predicted a true statement (S_{P}_{ₜᵣᵤₑ}=0.6>0.5). On the other hand, the second model in the three-tier cascade, i.e., P_{false}, has predicted a false statement s_{P}_{_{false}}=0.55>0.5. As a result, the final score (S_{f}) may be determined according to the above-mentioned formula, using the score s_{P}_{_{false}} provided by P_{false} model and its confidence weight (Wₘ):

$${s}_{f} = 0.5 - {w}_{M} ( 0.5 - {s}_{M} ) = 0.5 - 3 ( 0.5 - 0.55 ) = 0.65$$

### Example C

$${s}_{{P}_{true}} = 0.6 , {s}_{{P}_{false}} = 0.3 , {s}_{F 1} = 0.55 ⇒ {s}_{f} = 0.5 - 2 ( 0.5 - 0.55 ) ⇒ {s}_{f} = 0.6 \qquad ( C )$$

In example (C), the first model in the three-tier cascade, i.e., Pₜᵣᵤₑ has not predicted a true statement (S_{P}_{ₜᵣᵤₑ}=0.6>0.5). Also, the second model in the three-tier cascade, i.e., P_{false}, has not predicted a false statement ((S_{P}_{_{false}}=0.3<0.5). As a result, the final score (Sr) may be determined according to the above-mentioned formula, using the score S_{P}_{_{F1}} provided by F1 model and its confidence weight (Wₘ):

$${s}_{f} = 0.5 - {w}_{M} ( 0.5 - {s}_{M} ) = 0.5 - 2 ( 0.5 - 0.55 ) = 0.6$$

As illustrated in the last example, the third tier, i.e., F1, may resolve a situation where neither the first tier, i.e., Pₜᵣᵤₑ, predicts a true statement, nor the second tier, i.e., P_{false}, predicts a false statement. However, the final score takes into account that the F1 model is less confident than the P_{false} and Pₜᵣᵤₑ models. Indeed, even if the final scores in the second and third examples are determined from the same raw scores, i.e., 0.55, the final scores may be different, i.e., s_{f}=0.65 for the second example and s_{f}=0.60 for the third example.

In one or more embodiments, FIG. 8 represents a user interface 800 depicting the final stage of the algorithm, responsible for calculating and assigning the bars 806 to be plotted graphically for each statement made 808 based on the probability of truth 804 or lie 802. In another or further embodiment, user interface 800 may display bars 806 to be plotted graphically for each statement made 808 based on the probability of conviction, enthusiasm, or any other previously stated emotion. It may be desired to detect conviction, enthusiasm, or any other previously stated emotion in situations where lie detection is not desired such as when conducting employee or job applicant interviews. The algorithm, as explained before, may utilize three classification tiers-Precision True, Precision False, and F1 score—to accurately determine the confidence level of the output.

In some embodiments, a user may access the user interface 800 through a front-end server as well as either offline-mode back-end servers or online-mode back-end servers, each of which are described in more detail below. In such an embodiment, a middleware server may be used to facilitate communication and transfer data and other information between the front-end servers and the back-end servers.

In one or more embodiments, the algorithm may follow these steps for the Precision True tier. Statements classified as true in the Precision True tier may receive the highest rating (4 green bars), indicating high confidence in their truthfulness. Statements evaluated in the F1 score tier may be classified on a graduated scale: those with a probability of truth between 0% and 32% may be assigned 3 green bars, between 33% and 42% may receive 2 green bars, and between 43% and 50% may receive 1 green bar.

For Precision False, in one or more embodiments, the algorithm may operates as follows: Statements with a probability of being false above 72% in the Precision False tier are assigned 4 red bars, signifying maximum confidence in their lie. Statements with a probability between 62% and 72% in the Precision False tier and those above 65% in the F1 tier are rated with 3 red bars. For probabilities between 58% and 64% in both the Precision False and F1 tiers, 2 red bars are assigned, while probabilities between 50% and 57% are rated with 1 red bar.

This final stage of the algorithm enables graphical visualization of the results through a bar system, visually representing the level of confidence regarding the truthfulness or falsehood of the output statements. One skilled in the art would appreciate that these ranges Precision True, Precision False, and F1 score are merely examples and are in no way intended to be limiting. The ranges may vary depending on the use or how different confidence scores may be interpreted for different applications. For example, there may be any number of ranges and not just the ranges assigned to one, two, three, and four bars. There may be fewer or more ranges with a relevant number of bars assigned as needed.

While the aforementioned characteristic identification is focused on application to an answer, it may be used with other interactions. For example, the multi-tier classification model may be operative to identify early indications of deceitfulness during preliminary interactions, such as oaths and introductions. Further, in some embodiments, the multi-tier classification model may be operative to identify other characteristics in the absence of interaction with the individual. For example, when other participants in the multimedia content are engaging, the multi-tier classification model may be configured to extract any of the features, such as facial expressions, and may identify characteristics of the participant of interest.

### Example 3

Example 3 provides an example of accuracy of the tiers following the training of the individual tiers.

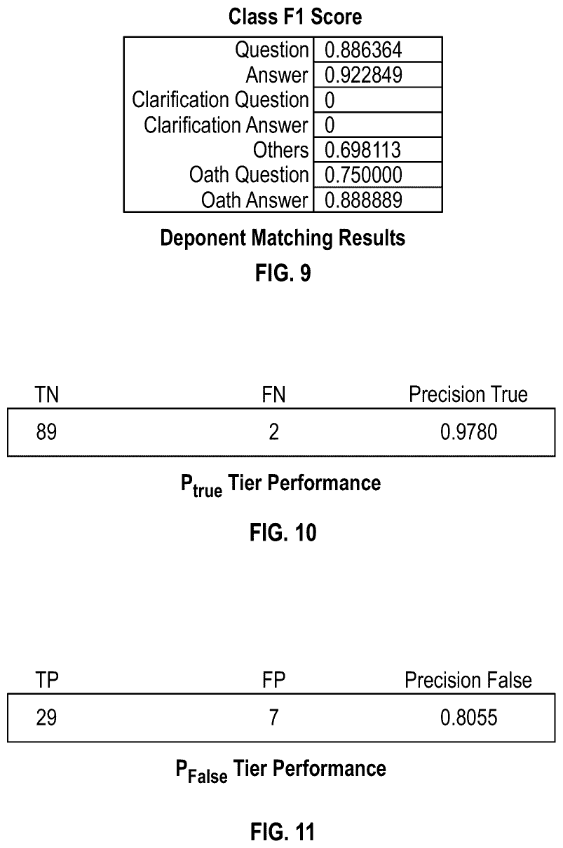

FIG. 9 depicts a table illustrating an overview of the system for each classification.

As shown in FIG. 10, the likelihood of a statement classified as an Answer being true is shown to be detectable at a 97% confidence. In the example shown, ninety-one (91) statements may be classified as true. Of those ninety-one statements, eighty-nine (89) statements were classified as a true negative (TN), and two were classified as a false negative (FN). A false negative (FN) occurs when the model incorrectly identifies a true statement as false.

As shown in FIG. 11, the likelihood of a statement classified as an Answer being false is shown to be detectable at an 80% confidence.

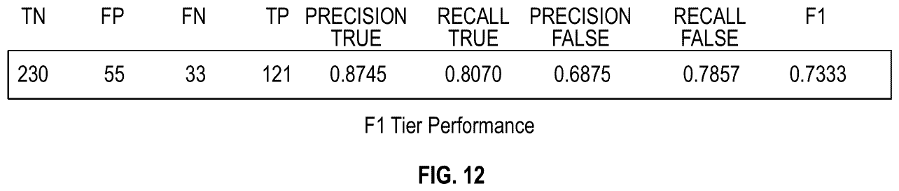

FIG. 12 illustrates an example of F1 performance. In the example shown, the F1 model correctly predicted true negative (TN) two-hundred-thirty (230) time and true positive (TP) one-hundred-twenty-one times (121). In contrast, the F1 model predicted a false positive (FP) fifty-five (55) times and a false negative (FN) thirty-three (33) times.

“PRECISION TRUE” corresponds to the F1 model correctly predicting true statements. In one embodiment, “PRECISION TRUE” may be calculated according to

$$\frac{TN}{( TN + FP )} .$$

“PRECISION FALSE” corresponds to the F1 model correctly predicting false statements and, in an embodiment, may be calculated as

$$\frac{TP}{( TP + FN )} .$$

The F1 score may, in one embodiment, be calculated according the weighted average of the PRECISION TRUE and PRECISION FALSE and the Recall True and Recall False. As illustrated in FIG. 12, the F1 score is calculated as 0.733, representing a 73% prediction accuracy in the F1 model.

### User Interface

In some embodiments, the system may further comprise a user interface. The user interface may display, on an electronic computing device, an interface configured to permit users to navigate the multimedia content.

In one embodiment, the user interface may comprise a transcript view comprising a transcript pane, a video pane, and a timeline pane.

In some embodiments, the transcript pane may comprise the transcript extracted from the data processing module discussed herein. Each line in the transcript may comprise a statement extracted from the multimedia content. In some embodiments, the transcript pane may comprise only statements from the participant of interest. In other embodiments, the transcript pane may comprise statements from the participant of interest and relevant statements for context. For example, the Question or Clarification may be displayed in addition to the Answer or Clarifying Questions. Of course, in another embodiment, any of the speech extracted from the multimedia content may be displayed.

In one embodiment, each line in the transcript may comprise a transcript meter operative to display a calculated deceptiveness of the sentence. However, in another embodiment, only statements extracted from the participant of interest may comprise the transcript meter. In a further embodiment, the transcript meter may be further operative to display a likelihood of the statement being true and/or false.

In some embodiments, the meter may be a visual representation. In one embodiment, the meter may be configured as a horizontally oriented rectangle, divided in half by a vertical line. A colored line may extend off one side of the vertical line, for example a horizontal red line extends towards the left and a horizontal green line may extend towards the right. It is contemplated that the length the line extends off the vertical line may be associated with the value of the respective horizontal line.

For example, a value of 0.5 may be visually represented on the transcript pane by a horizontal green line extending from the center-point halfway to the right edge of the rectangle. A value of 1 would be visually represented by a horizontal green line extending from the center-point all the way to the right edge of the rectangle. Negative values, on the other hand, may result in a red line extending some distance to the left of the center-point. For example, a value of −0.5 would be visually represented by a horizontal red line extending from the center-point halfway to the left edge of the rectangle. These values, and their respective displays, may, in some embodiments, be representative of the confidence of the true/false prediction determined by the system. Of course, other manners of displaying the confidence of the true and/or false prediction may be utilized.

In one embodiment, the video pane may comprise a scrubber configured to permit the user to navigate along the video. The video pane may further comprise any standard controls that a person of ordinary skill in the art may desire, including, without limitation, a play button, a pause button, and a stop button.

The video pane may be further operative to display the video component of the multimedia content on the graphical user interface. In one embodiment, the video pane may display the video file associated the participant of interest extracted by the gallery view module.

In another embodiment, the timeline pane may be configured to display a representation of the transcript pane in correlation with the video pane. It is contemplated that displaying the transcript pane in correlation with the video pane may permit visualization of an overall quality of the multimedia content.

The timeline pane may be displayed in correlation with the video and may comprise a plurality of visual indicators, each representing the meter from the transcript pane. In some embodiments, the meter may be transposed such that the red line may extend vertically downwards from the centerpoint and the green line may extend vertically up from the centerpoint.

It is contemplated that any of the transcript pane, the video pane, and the timeline pane may be synchronized with another of the panes. In one embodiment, each of the transcript pane, the video pane, and the timeline pane may be synchronized with one another. As an illustrative example, the video file may comprise two-hours of content and the transcript may comprise a thousand lines of text. The transcript pane, video pane, and timeline pane may be synchronized such that a selection of any point in the video may display the corresponding line in the transcript on the timeline pane and its corresponding metric on the timeline pane. It should be recognized that as the transcript pane, video pane, and timeline pane are all synchronized, navigating to a point in the multimedia file in any of the panes may result in an equivalent change in the remaining panes.

In some embodiment, the system may further comprise a participant library comprising at least one participant. Each participant in the participant library may comprise an ID. In one embodiment, the ID may comprise any of the participant's identifying features, including, for example, the participant role and scenario associated with the multimedia content (i.e., deposition). It is contemplated that the participant library may permit the system to compare the participant at multiple times, such as on different days, to identify participant-specific characteristics. Further, the participant library may be operative to train any of the system. In one such embodiment, the participant library may be operative to train any of the system according to identifying information of the user.

In some embodiments, the system may be operative to train the tiers according to any of the information associated with the participant. For example, the system may identify participant specific characteristics that indicate the participant is being deceptive and may train the tiers specific to each participant.

In one or more embodiments, a pool of front-end servers may be used to train and maintain the algorithm. The front-end servers may be load-balanced and auto-scaled to accommodate any expected web traffic. In some embodiments, the front-end servers may be virtual servers. In other embodiments, the front-end servers may be physical servers. The front-end servers may serve the website's React UI. In the same or other embodiments, the front-end servers may also expose an API which said UI and other servers may call as needed. In some embodiments, the front-end servers may be maintained on machines such as, for example only, the AWS EC2 T2.small instances that may run Ubuntu Linux 20.04.x. The front-end servers may run 3.3 GHZ Intel Xeon Scalable CPUs, where there may be one core per server, with 2 GB of RAM and 50 GB of gp2-type SSD storage. It is contemplated that one skilled in the art would appreciate that any type of suitable server, operating system, CPU, RAM storage, and hard drive may be used as long as it is capable of performing the training, maintaining the necessary functional requirements, communicating between necessary nodes, and other aspects which may be desired to carry out the functions and algorithms disclosed herein. In one or more embodiments, relatively low-powered machines may be utilized. In such an embodiment, it may be desired to maintain a large pool of machines rather than a smaller pool of more high-powered machines. In other embodiments, a smaller pool of high-powered machines may be utilized.

In one or more embodiments, offline-mode back-end servers may be utilized. A pool of offline-mode back-end servers may be maintained where each of which may be capable of running one or more analysis of at least one RTMP or uploaded video file at a time. In such an embodiment, the offline-mode back-end may be load balanced and auto-scaled. The offline-mode back-end servers may be, for example, AWS EC2 G4DN.xlarge instance machines, running Ubuntu Linux 20.04.x. The machines may be explicitly designed and tuned for AI-oriented tasks. The machines may run 2.5 GHZ Intel Cascade Lake 24C processors, four cores per server, with 16 GB of RAM and 80 GB of gp2-type SSD storage, plus an NVIDIA T4 Tensor Core GPU. It is contemplated that one skilled in the art would appreciate that any type of suitable server, operating system, CPU, GPU, RAM storage, and hard drive may be used as long as it is capable of performing the training, maintaining the necessary functional requirements, communicating between necessary nodes, and other aspects which may be desired to carry out the functions and algorithms disclosed herein.

In other embodiments, online-mode back-end servers may be substantially identical to the offline-mode back-end servers except the online-mode back-end servers may be maintained by a pool of more powerful servers. In such embodiments, the machines may be AWS EC2 G4DN.2×large instances machines. These machines may have 8 CPU cores rather than 4, 32 GB RAM rather than 16 GB, and the same amount of SSD storage. Again, it is contemplated that one skilled in the art would appreciate that any type of suitable server, operating system, CPU, GPU, RAM storage, and hard drive may be used as long as it is capable of performing the training, maintaining the necessary functional requirements, communicating between necessary nodes, and other aspects which may be desired to carry out the functions and algorithms disclosed herein.

In one or more embodiments in accordance with the present disclosure, the system may include middleware servers. The middleware servers may act as intermediaries or “traffic directors” between the pool of front-end servers and the pool of back-end servers. The middleware servers may be maintained on any such suitable machine such as, for example, an AWS EC2 T2.medium instance, running Ubuntu Linux 22.04.x on a 3.3 GHZ Intel Xeon Scalable CPU (2 cores), 4 GB of RAM, and 50 GB of gp2-type SSD storage. It is contemplated that one skilled in the art would appreciate that any type of suitable server, operating system, CPU, GPU, RAM storage, and hard drive may be used as long as it is capable of performing the training, maintaining the necessary functional requirements, communicating between necessary nodes, and other aspects which may be desired to carry out the functions and algorithms disclosed herein.

In the same or other embodiments, there may be one or more database servers in communication with front-end servers, back-end servers, and/or the middleware servers. The database server may be capable of hosting all of the necessary training data. The database servers may be managed by machines such as, for example, a PostgreSQL server instance on AWS RDS. The machine may run a 3.1 GHZ Intel Xeon Scalable processor, with 1 GB of RAM and 100 GB of iol-type provisioned IOPS SSD storage. It is contemplated that one skilled in the art would appreciate that any type of suitable server, operating system, CPU, GPU, RAM storage, and hard drive may be used as long as it is capable of performing the training, maintaining the necessary functional requirements, communicating between necessary nodes, and other aspects which may be desired to carry out the functions and algorithms disclosed herein.

In some embodiments, S3 servers may be utilized to share assets among different servers, or between web-clients and servers. It is contemplated that one skilled in the art would appreciate that any type of suitable server may be used as long as it is capable of writing to S3 “buckets” and reading from the said buckets.

In one or more embodiments, the system, algorithms, and/or user interfaces may be hosted on a third party such as AWS. In such an embodiment, the third party may be relied on for extensive use and maintenance of networking hardware such as routers and machines hosting DNS service, load-balancing, autoscaling, code-deployment, serving CDN content, sending mail and SMS messages, managing user accounts, manipulating media via AWS MediaConvert, and the like.

Furthermore, some portions of the detailed description are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the example embodiments, the steps carried out require physical manipulations of tangible quantities for achieving a tangible result.

Moreover, other implementations of the example embodiments will be apparent to those skilled in the art from consideration of the specification and practice of the example embodiments disclosed herein. Various aspects and/or components of the described example embodiments may be used singly or in any combination. It is intended that the specification and examples be considered as examples, with a true scope and spirit of the embodiments being indicated by the following claims.

What is claimed is:

1. A system for automatic role detection of participants of interest, the system comprising:
a multimedia file comprising an interview of one or more participants of interest and one or more file components, the one or more file components comprising one or more of a transcript file, an audio file, and a video file;
a processor operable to:
segment the one or more file components into a plurality of segments;
assign, via an assigning algorithm, a role to each of the one or more participants of interest, wherein the assigning algorithm is a machine learning algorithm, the machine learning algorithm including a computer-implemented method comprising:
receiving, from the one or more file components, an input dataset comprising the plurality of segments, each of the plurality of segments comprising one or more partial or complete sentences spoken by the one or more participants of interest;
determining a sentence syntax structure for each of the one or more partial or complete sentences from each of the plurality of segments;
identifying the one or more participants of interest contained within the multimedia file, wherein identifying the one or more participants of interest comprises determining which of the one or more participants of interests is responsible for each of the plurality of segments;
classifying, based on the determined sentence syntax, each of the plurality of segments into a plurality of distinct categories; and
assigning, based on which of the plurality of distinct categories is identified with respect to each of the one or more participants of interest, a role to each of the one or more participants of interest;
a user interface configured to dynamically display the multimedia file.

2. The system of claim 1, further comprising a gallery view module configured to isolate one or more video streams, wherein at least one of the one or more video streams is assigned to at least one of the one or more participants of interest.

3. The system of claim 2, wherein the user interface is further configured to label at least one of the one or more video streams assigned to at least one of the one or more participants of interest with the role assigned to the one or more participants of interest.

4. The system of claim 1, wherein the role to be assigned to at least one of the one or more participants of interest is a deponent.

5. The system of claim 1, wherein the plurality of distinct categories comprise Question, Answer, Clarification Question, Clarification Answer, Other Speakers, Oath Question, and Oath Answer, wherein Answer, Clarification Question, and Oath Answer are sentences articulated by a deponent.

6. The system of claim 5, wherein only a portion of the plurality of distinct categories is associated with the role.

7. The system of claim 6, wherein Oath Answer, wherein Answer, Clarification Question, and Oath Answer are associated with the role of a deponent.

8. A method for automatic role detection of participants of interest, the method comprising:
receive, from a front-end server, a multimedia file comprising an interview of one or more participants of interest and one or more file components, the one or more file components comprising one or more of a transcript file, an audio file, and a video file;
segment the one or more file components into a plurality of segments;
receive, from the one or more file components, an input dataset comprising the plurality of segments, each of the plurality of segments comprising one or more partial or complete sentences spoken by the one or more participants of interest;
determine a sentence syntax structure for each of the one or more partial or complete sentences from each of the plurality of segments;
identifying the one or more participants of interest contained within the multimedia file, wherein identifying the one or more participants of interest comprises determining which of the one or more participants of interests is responsible for each of the plurality of segments;
classifying, based on the determined sentence syntax, each of the plurality of segments into a plurality of distinct categories;
assigning, based on which of the plurality of distinct categories is identified with respect to each of the one or more participants of interest, a role to each of the one or more participants of interest; and
dynamically displaying, on a user interface, the multimedia file.

9. The method of claim 8, further comprising a gallery view module configured to isolate one or more video streams, wherein at least one of the one or more video streams is assigned to at least one of the one or more participants of interest.

10. The method of claim 9, wherein the user interface is further configured to label at least one of the one or more video streams assigned to at least one of the one or more participants of interest with the role assigned to the one or more participants of interest.

11. The method of claim 8, wherein the role to be assigned to at least one of the one or more participants of interest is a deponent.

12. The method of claim 8, wherein the plurality of distinct categories comprise Question, Answer, Clarification Question, Clarification Answer, Other Speakers, Oath Question, and Oath Answer, wherein Answer, Clarification Question, and Oath Answer are sentences articulated by a deponent.

13. The method of claim 12, wherein only a portion of the plurality of distinct categories is associated with the role.

14. The method of claim 13, wherein Oath Answer, wherein Answer, Clarification Question, and Oath Answer are associated with the role of a deponent.

15. At least one non-transitory computer-readable medium comprising a plurality of instructions that, when executed by at least one processor, are configured to:
receive a multimedia file comprising an interview of one or more participants of interest and one or more file components, the one or more file components comprising one or more of a transcript file, an audio file, and a video file;
segment the one or more file components into a plurality of segments;
receive, from the one or more file components, an input dataset comprising the plurality of segments, each of the plurality of segments comprising one or more partial or complete sentences spoken by the one or more participants of interest;
determine a sentence syntax structure for each of the one or more partial or complete sentences from each of the plurality of segments;
identifying the one or more participants of interest contained within the multimedia file, wherein identifying the one or more participants of interest comprises determining which of the one or more participants of interests is responsible for each of the plurality of segments;
classifying, based on the determined sentence syntax, each of the plurality of segments into a plurality of distinct categories;
assigning, based on which of the plurality of distinct categories is identified with respect to each of the one or more participants of interest, a role to each of the one or more participants of interest; and
dynamically displaying, on a user interface, the multimedia file.

16. The at least one non-transitory computer-readable medium of claim 15, further comprising a gallery view module configured to isolate one or more video streams, wherein at least one of the one or more video streams is assigned to at least one of the one or more participants of interest.

17. The at least one non-transitory computer-readable medium of claim 16, wherein the user interface is further configured to label at least one of the one or more video streams assigned to at least one of the one or more participants of interest with the role assigned to the one or more participants of interest.

18. The at least on non-transitory computer-readable medium of claim 15, wherein the role to be assigned to at least one of the one or more participants of interest is a deponent.

19. The at least one non-transitory computer-readable medium of claim 15, wherein the plurality of distinct categories comprise Question, Answer, Clarification Question, Clarification Answer, Other Speakers, Oath Question, and Oath Answer, wherein Answer, Clarification Question, and Oath Answer are sentences articulated by a deponent.

20. The at least one non-transitory computer-readable medium of claim 19, wherein only a portion of the plurality of distinct categories is associated with the role, and wherein Oath Answer, wherein Answer, Clarification Question, and Oath Answer are associated with the role of a deponent.
